(19) United States
(12) Patent Application Publication
(10) Pub. No.: US 2026/0307312 A1
(43) Pub. Date: Oct. 8, 2026

(54) MECHANICAL EJECTOR

(71) Applicant: Merkle Portugal, Unipessoal, LDA, Marinha Grande (PT)

(72) Inventor: Ricardo Miguel Elias Gomes LOPES, Barcelona (ES)

(21) Appl. No.: 19/480,659

(22) PCT Filed: Jun. 3, 2024
(86) PCT No.: PCT/EP2024/065214

§ 371 Date: Oct. 31, 2025

(30) Foreign Application Priority Data
Jun. 12, 2023 (DE) 10 2023 115 262.9

(51) Int. Cl. B29C 45/40; B22D 17/22

(52) U.S. Cl. CPC B29C 45/401; B22D 17/2236

(57) ABSTRACT

The invention relates to a device, in particular inclined ejector (1), for demolding a cast part (14) with an undercut (141) from a cavity plate (93) for a casting process or an injection molding process (9) comprising:
a guide element (2);
an ejector element (3) which is guided in the guide element (2) in a translationally sliding manner in a first direction and has a first end which can be coupled to an ejector head (4);
a push element (5) which is guided in the guide element (2) in a translationally sliding manner in a second direction, wherein the first and second directions enclose a guide angle unequal to 0°;
a coupling mechanism (6) which is designed to mechanically couple translational movements of the ejector element (3) and the push element (5) in their first and second directions respectively;
a stabilization arrangement (61) which is arranged between the first end of the ejector element (3) and the guide element (2) in order to reduce a deflection of the ejector element (3) transverse to the first direction of the translational movement of the ejector element (3) or transverse to the second direction of the translational movement of the push element (5).

### TECHNICAL FIELD

The present invention relates to a device for demolding undercuts within tools for plastic injection molding or within tools for die casting. Such a device is also referred to as an ejector device.

### BACKGROUND OF THE INVENTION

In the injection molding of any type of injection-molded parts or die-cast parts, it is necessary to demold the cast or molded part from the tool, for which ejectors are used. Demolding of a cast or molded part by the stroke or relative movement of the ejector(s) with respect to the tool plate(s), in particular with respect to an ejector plate, represents the state of the art for this purpose. The ejector plate is a displaceably mounted tool plate which, within an ejector device, transfers the stroke generated by an ejection cylinder to the ejector(s). Demolding may take place in a direction perpendicular or at an angle to the ejector plate. Ejectors known as straight ejectors act in a plane which forms at a right angle, i.e. 90°, to the horizontal plane of the ejector plate. Ejectors known as inclined ejectors act in a plane which forms at an angle smaller or greater than 90° with respect to the horizontal plane of the ejector plate. In injection molds or die casting molds that, due to the geometry of the part to be demolded, have certain regions with the aforementioned undercuts, demolding of the cast or molded part solely by vertical relative movement of the straight ejector(s) with respect to an ejector plate is not possible. It is therefore prior art to use inclined ejectors for the process of demolding undercuts by a non-vertical relative movement of the inclined ejector(s) with respect to an ejector plate.

Ejector devices of this type, installed within the injection molding tool or die casting tool, are activated at the moment of ejection by inclined ejectors which may form plungers. Inclined ejectors of this type are advanced by a hydraulic cylinder. The latter are also referred to as ejection cylinders and generate a stroke by means of which the inclined ejector, in several embodiments known from the prior art, moves through the tool in the demolding direction of the injection mold or die casting mold. In doing so, the inclined ejector may be guided either by a sliding device or by way of passages, in particular by bores within the tool plates. An ejector device implemented by means of an inclined ejector is generally configured, with respect to the sliding device or the passage, such that it redirects the stroke movement of the inclined ejector in the demolding direction into a movement direction inclined thereto. Consequently, the inclined ejector moves in a plane that forms at an angle smaller or greater than 90° with respect to the stroke direction of the ejection cylinder or an ejector plate. This angle, also referred to as demolding angle or release angle, is determined essentially by the shape and angular position of the sliding device or the passage within the tool plates. The angle formed by the respective undercut, in particular with respect to the ejector plate, is referred to as the undercut angle and may have a so-called negative geometric value, for example between minus 15°and 30° with respect to a horizontal plane, the horizontal plane being formed parallel to the plane of the tool plates and/or the ejector plate. Alternatively, the undercut angle may have a so-called positive geometric value, for example between plus 15° and 30° with respect to the horizontal plane.

From the prior art, ejector devices are known in which no sliding device or passage is used to guide an inclined ejector within tool plates. EP 2 899 010 B1 discloses such a device for demolding injection-molded parts by means of an inclined ejector within an ejector device, in which the inclined ejector is mounted by means of a guide bushing and is indirectly driven by an ejection cylinder by way of a rack-and-pinion type gear. The ejection cylinder and the inclined ejector are connected to each other indirectly by the rack gear. The inclined ejector is designed as a rack in its section facing the second end; this section is referred to there as a slide. This slide is guided with frictional engagement in a first passage within the guide bushing and is in positive contact with a push rod within the guide bushing, for which purpose the section of the push rod facing the first end is likewise designed as a rack. The push rod is likewise guided with frictional engagement in a second passage within the guide bushing. Due to the frictional guidance of the section of the inclined ejector, i.e. the slide, as well as the section of the push rod facing the first end within the guide bushing, there is no need for any additional guidance of the inclined ejector within the tool. The guide bushing may be mounted within an abutment of a tool plate. The rack section of the slide interacts with the rack section of the push rod in such a way that the linear movement of the push rod is transferred transversely to the slide by a positive, mutual meshing of the two rack sections in the manner of a helical gear, and the inclined ejector is thus shifted from a first position into a second position. A first disadvantage of this solution is that the manufacture of rack sections is technically complex and becomes uneconomical especially for greater lengths of the rack sections. A further disadvantage of this solution is that the respective rack sections have to be formed over a relatively long section of both the slide and the push rod in order to enable large strokes.

A further disadvantage of this solution is that, due to the geometry of the respective rack sections, a section with a smaller cross-section and thus less material is followed by a section with a larger cross-section and thus more material, which leads to a body with varying cross-sections and varying bending resistances. The positive-locking force input between the two meshing rack sections therefore occurs over varying cross-sections with varying bending resistances, which can lead to local stress peaks due to bending. Owing to a superimposed alternating tensile-compressive load, the varying cross-sections of the rack region have a particularly adverse effect on the fatigue strength of the slide. As a result, the inclined ejector is subjected to a high load in its section facing the second end, i.e. the slide, while the section of the push rod facing the first end is also subjected to a high load. The load on the slide relative to the push rod is comparatively higher due to the additional transverse force component caused by the gear action between the helical push rod and the helical slide. The comparatively high load on the section of the inclined ejector facing the second end is compounded by the load on its section facing the first end, which absorbs the forces of the mold tool, namely the demolding plate, by way of the ejector head; these forces are superimposed on the demolding force and additionally load the inclined ejector.

A further disadvantage is that the so-called transition point of the positive-locking force input between both rack sections is located in the region of the slide facing the second end and thus the demolding force (thrust force) of the inclined ejector is generated geometrically remote from the undercut region to be demolded. There is also the drawback that the location of guidance of the inclined ejector by means of the guide bushing within the tool is geometrically spaced apart from the location where the demolding force of the inclined ejector is introduced within the ejector device, so that the inclined ejector is mechanically unguided over a longer section. Between the point of ejection immediately below the undercut region to be demolded and the transition point between the push rod and the slide, a lever arm is formed, whereby the aforementioned alternating bending stress of the slide is superimposed by the aforementioned alternating tensile-compressive load of the slide. This can in particular lead, in the case of an embodiment of such an inclined ejector having a large stroke, to mechanical instability of the section of the inclined ejector facing the first end. The structural-mechanical disadvantages described can lead to the demolding forces being limited in such an inclined ejector, which in turn directly affects the size of the undercut to be demolded in each case and indirectly the size and weight of the injection-molded part to be demolded. A further disadvantage is that a pitch error may occur between the two rack sections, for example due to a missing tooth or a damaged tooth flank, which results in complete failure of the inclined ejector. In addition, the friction-bearing rack drive of such an inclined slider must be permanently lubricated, which can result in contamination due to fine abrasion between the racks or due to dust introduced from the outside. The friction thus caused can, together with all the disadvantages mentioned, lead to premature wear and premature failure of the inclined ejector. In the event of damage to the slide or the push rod, all elements of the inclined ejector must also be replaced, because the guide bushing is also exposed to increased wear due to its structural-mechanical loading and the additionally arising friction.

None of the solutions known from the prior art makes it possible to provide a low-wear and low-deformation ejector device that provides high demolding forces, in particular for producing large-format and/or heavy injection-molded or die-cast parts with undercuts.

It is therefore an object of the invention to further develop the straight or inclined ejector described at the outset for an ejector device of a plastic injection mold or die-casting tool such that, on the one hand, it has high mechanical stability and robustness to generate large demolding forces while at the same time being simple and low-wear and, on the other hand, is made up of few replaceable and extendable, preferably uniformly designed elements in order to eliminate the disadvantages of the prior art.

### DISCLOSURE OF THE INVENTION

This object is achieved by an inclined ejector for an ejector device for demolding undercuts within a tool for plastic injection molding or die casting having the features of claim 1 and the dependent claims.

Further embodiments are specified in the dependent claims.

Accordingly, a device, more particularly an inclined ejector, for demolding a cast component having an undercut from a cavity plate for a casting process or an injection molding process with an ejector is proposed, comprising:
a guide element;
an ejector element which is guided in the guide element in a translationally sliding manner in a first direction and which has a first end that can be coupled to an ejector head;
a push element which is guided in the guide element in a translationally sliding manner in a second direction, the first and second directions enclosing a guide angle unequal to 0°;
a coupling mechanism configured to mechanically couple translational movements of the ejector element and of the push element in their respective first and second directions; and
a stabilization arrangement which is arranged between the first end of the ejector element and the guide element in order to reduce a deflection of the ejector element transverse to the first direction of the translational movement of the ejector element and/or transverse to the second direction of the translational movement of the push element.

A first group of functional elements of a device, namely a tool for plastic injection molding or die casting in which the inclined ejector according to the invention is used, is formed by differently configured tool plates which perform different functions within the device. The different embodiments of the tool plates may in particular comprise a stationary, non-displaceable mold plate (cavity plate) and a non-stationary, i.e. displaceable, movable mold plate (core plate). A further displaceable tool plate may be provided by an ejector plate. The displaceable tool plates can be shifted within the device by different ejection cylinders (hydraulic cylinders) from a first position, a so-called molding position, into a second position, a so-called demolding position.

A further group of functional elements of the inclined ejector according to the invention for an ejector device for demolding undercuts within the aforementioned device comprises different embodiments of further ejector elements which perform different functions within the ejector device. The different embodiments of these further ejector elements may on the one hand constitute a first push element mounted in a guide element and arranged therein so as to be displaceable, and on the other hand a second ejector element mounted in the same guide element and arranged therein so as to be displaceable, which are shifted within the device from a first position into a second position by means of a first ejection cylinder and an ejector plate.

A third group of functional elements of the inclined ejector according to the invention for an ejector device within the device mentioned above comprises a guide element with passages provided therein as well as a guide slot provided therein. The passages accommodate a push element arranged displaceably therein or an ejector element arranged displaceably therein. The push element and the ejector element operatively connected thereto by means of a coupling mechanism are shifted within the device from a first position into a second position by means of the aforementioned ejector plate and by means of the aforementioned first ejection cylinder.

A first advantageous aspect of the solution according to the invention is that a first ejection cylinder arranged in a device for a casting or injection molding process can generate a stroke which can be transmitted by a first mechanical connection to an ejector plate and, further, by the ejector plate by means of a second mechanical connection to a push element and further by means of a further mechanical connection (coupling mechanism) from the push element to an ejector element and to an ejector head arranged thereon. The surface direction, i.e. the plane, of the tool plates arranged in the device so as to be displaceable or non-displaceable, and thus of the ejector plate, extends transverse to the displacement direction, i.e. perpendicular or inclined to the movement direction of the push element and/or of the ejector element coupled thereto. By the displacement of the ejector element, an ejector head arranged on the ejector element can be moved in an ejection direction. The ejector plate represents, within the device, a first embodiment of a tool plate arranged so as to be displaceable. The ejection cylinder, usually a hydraulic drive unit, may in particular be arranged within the device between a base plate and the ejector plate, wherein the base plate and an end plate constitute further embodiments of tool plates arranged within the device so as to be non-displaceable and close the device to the outside. The stroke generated by the ejection cylinder causes, by way of the ejector plate and optionally by way of a push-element extension, a displacement of the push element from a first into a second position in its longitudinal direction, which takes place in a first direction.

The push element is accommodated in a first passage of a guide element so as to be displaceable, the guide element representing a type of guide body or guide bushing accommodated within the device in a core plate (movable mold plate), the core plate representing within the device an embodiment of a tool plate arranged so as to be displaceable. The core plate accommodates, on the one hand, at least one guide element in at least one recess and, on the other hand, at least one ejector head in at least one pocket. In the guide element, the ejector element is further accommodated in its longitudinal direction by means of a second passage in a second direction.

The ejector element is operatively connected to the push element by means of a coupling mechanism, the coupling mechanism constituting a mechanical connection (coupling) between the push element and the ejector element. Due to the coupling between the push element and the ejector element by means of the coupling mechanism, a displacement of the push element in a first direction from a first position into a second position brings about a simultaneous displacement of the ejector element in a second direction from a first position into a second position. The ejector head arranged on the ejector element can thereby be displaced in the second direction of the ejector element from a first position into a second position and eject an undercut of a cast part from a core plate (movable mold plate).

A further advantageous aspect of the solution according to the invention is that the coupling mechanism and a stabilization arrangement formed therein between the ejector element and the push element are arranged in geometric proximity to the connection of the ejector head to a first end of the ejector element facing the ejector head. In this way, high thrust forces and thus high demolding forces can be generated in immediate spatial proximity to the ejector head and thus near a critical point of the ejection process for ejecting a cast part having at least one undercut from a cavity plate.

Moreover, the stabilization arrangement ensures, on the one hand, that the ejector device can always return to the same, reproducible position after the ejection process and, on the other hand, that the ejector head can always perform the ejection operation at the same, reproducible position within the device.

A further advantage of the solution according to the invention is that, in the inclined ejector according to the invention, the mechanical properties of bending-stiff, maintenance-free ejector and push elements can be advantageously combined with the properties of a maintenance-free and mechanically highly loaded guide element, wherein the guide element can in particular be designed in the manner of a guide bushing. In this context, bending-stiff means that the ejector element and the push element can in particular be designed as solid, in particular flattened round bars which have high moments of resistance to bending, torsion and transverse forces. The ejector element and the push element have low elasticity and, in particular, have no spring properties in their respective longitudinal directions (first and second directions). As a result, the inclined ejector according to the invention has high fatigue-endurance properties, in contrast to inclined ejector solutions designed merely for limited life which include springs or elastically designed link rods or ejector components with lower mechanical strengths.

A further advantage of the solution according to the invention lies in the adaptability of the inclined ejector by lengthening or shortening the push element in order to adapt the inclined ejector to the geometry of a device for a casting or injection molding process, in particular to the number, the dimensions, the weights and the respective spacings of the tool plates used therein. For this purpose, the push element can advantageously be lengthened by adding a push-element extension at its end facing the second end. Such a push-element extension can be implemented by an extension that can be plugged into or screwed into the second end of the push element.

According to a further advantage of the solution according to the invention, the operative connection between the ejector element and the push element is established by means of a coupling mechanism. Here, the coupling mechanism consists, on the one hand, of two recesses which are each located in a section between the first end of both the ejector element and the push element and the guide element and which form a guide for an elongated driver of the coupling mechanism. The recesses may have a wedge-shaped or rectangular cross-section. The respective first ends of the recess, of the ejector element and of the push element face the ejector head; the second ends of the recess, of the ejector element and of the push element face away from the ejector head.

Here, the coupling mechanism consists, on the other hand, of the driver located in the recesses, which extends between the ejector element and the push element and can be detachably fastened to the push element. The driver is fastened within the recess located in the push element, preferably by a fastening means in the manner of a screw connection, the driver being guided displaceably along its longitudinal direction in at least one of the recesses in the push element or in the ejector element. Other conceivable fastening means for fastening the driver to the push element may be a rivet connection or a pin located in bores, the bores being located in the region of the recess of the push element as well as in the driver.

According to a further advantage, the inclined ejector according to the invention is provided with a stabilization arrangement within the coupling mechanism. The stabilization arrangement is formed by the reception of the driver in the recesses of the ejector element and of the push element. The stabilization arrangement, as a component of the coupling mechanism, is therefore arranged in the recess between the first end of the ejector element and of the push element and the guide element in order to stabilize these against an elastically bending deformation, i.e. to reduce or to prevent a deflection of the ejector element transverse to the first direction of its translational movement, in other words the ejection direction. The stabilizing effect thus produced aims at improving the operational reliability of the inclined ejector in such a way that transverse forces acting on the inclined ejector, which in particular cause a deflection of the ejector element transverse to the first direction of the translational movement of both the ejector element and the push element, can be effectively reduced, up to and including prevention of an undesired mutual splaying apart of the first region of the ejector element facing the ejector head relative to the first region of the push element facing the ejector head.

According to a further advantage, by means of the coupling mechanism extending between the push element and the ejector element, a driving action can be generated from the push element onto the ejector element. The driving action that occurs is determined, on the one hand, by the guide angle that is formed between the ejector element and the push element by the orientation of passages in a core plate in which the ejector element and the push element are guided, and, on the other hand, by the inclination angles which represent the orientation of the recess in the ejector element for accomodating the driver with respect to the longitudinal extent of the ejector element and/or the orientation of the recess in the push element for accomodating the driver with respect to the longitudinal extent of the push element. The geometric relationship that is established between the push element and the ejector element thus has a direct influence on the magnitude of the thrust action which the coupling mechanism between the ejector element and the push element can generate together with the stroke of an ejector plate. The thrust action achievable by the coupling mechanism and the driver contained therein is mechanically equivalent to the action of a cam within a thrust gear. By selecting the inclination angle of the coupling mechanism, due to the cam-like action equivalent of the driver, a different gear action between the push element and the ejector element can be generated, the gear action in the mechanical sense corresponding either to a gear-up with an accelerating effect or to a gear-down with a decelerating effect. The greater the inclination angle of the coupling mechanism and the greater the stroke of the push element, the greater the gear action from the push element to the ejector element. A smaller inclination angle of the coupling mechanism and a smaller stroke of the push element, on the other hand, produce a lesser gear action on the ejector element. Thus, by means of the orientation and the inclination angle of the driver of the coupling mechanism between the push element and the ejector element, acceleration or deceleration of the demolding process of an undercut can be achieved by means of the inclined ejector according to the invention. The inclination angle of the driver of the coupling mechanism on the ejector element corresponds to an angle of 0° when the driver points in a direction facing away from the ejector head. Analogously, the inclination angle of the driver of the coupling mechanism on the push element corresponds to an angle of 0° when the driver points in a direction facing away from the ejector head. An inclination angle of the driver on the push element at an angle greater than 90° with respect to the longitudinal axis of the push element produces acceleration. An inclination angle smaller than 90° with respect to the longitudinal axis of the push element produces deceleration.

In a preferred embodiment, the inclined ejector according to the invention has a guide element in the form of a body preferably of rotational symmetry, in particular of cylindrical design. A guide element designed in this way may be accommodated in a recess within a core plate of a device for a casting or injection molding process. The core plate represents an embodiment of a tool plate which has pockets in which ejector heads arranged on the ejector element can be accommodated.

The fixing of the guide element to the core plate can be effected by means of a fixing element which, on the one hand, is accommodated in a recess in a first section of the guide element located at the end of the guide element that faces the ejector head and, on the other hand, preferably fixes the guide element to the core plate by means of a screw connection. The guide element can have passages for accommodating the ejector element and the push element, by means of which the ejector element and the push element are guided in a translationally sliding manner in the guide element in a first and second direction respectively. The directions of the passages within the guide element are at a guide angle to each other. In a first embodiment of the guide element, this guide angle may in particular be “acute”, i.e. between 10° and 20°, and is formed between the respective longitudinal axis of the ejector element and of the push element. In a further embodiment of the guide element, this guide angle may be between 10° and 45°. A preferred embodiment of the guide element, in addition to the passages contained therein for accommodating the push element and the ejector element, may have a guide slot in which the driver of the coupling mechanism can be accommodated when the push element is moved back from the ejection process. In a preferred embodiment of the inclined ejector, the driver can be moved by means of the push element into different positions within the guide slot of the guide element, wherein a first position may constitute a mechanical stop in the section of the guide element located at the end of the guide element that faces away from the ejector head, and a second position may constitute the mouth of the guide slot in the section of the guide element located at the end of the guide element that faces the ejector head. A further position may lie outside the guide slot and thus outside the guide element. A first advantage of the preferred embodiment is that a maximum stroke of the inclined ejector can be generated by it, in that the driver can plunge completely into the guide element within the guide slot. A further advantage of the preferred embodiment is that, by plunging into the guide slot, the driver, in addition to the stabilization arrangement provided by the coupling mechanism, receives a further mechanical fixing within the guide element, which, in particular in the case of a short ejection stroke of the ejector device and at maximum ejection force, additionally contributes to the robustness and fatigue endurance of the inclined ejector.

In a further embodiment, the guide element may be designed with passages but without a guide slot. Such an embodiment may be used in ejector devices in which the requirement of a maximum ejection stroke is not present, for example in short-stroke ejector devices.

A further advantage of the solution according to the invention lies in the possibility of modularly combining elements of similar design and/or dimension in order to provide different embodiments of the inclined ejector according to the invention, in particular different devices for a casting or injection molding process, with cavity plates of different dimensions and weights and core plates with ejection geometries and/or a different number of tool plates. For example, in an ejector device designed to be so variable, a similarly designed guide element can be combined with a similarly designed ejector element and with a push element complementary thereto. The similarity of the guide element is characterized in particular by its dimensions, the arrangement of the passages within the guide element, the selection of the guide angle between the passages, and by the cross-section and diameter of the passages in which the ejector element and the push element are mounted independently of each other in the passages. For example, with different embodiments of the guide element, different embodiments and effects of inclined ejectors can be made possible by additionally combining a push element and an ejector element by means of a coupling mechanism in such a way that either an accelerating or a decelerating effect on the part to be ejected can be generated in different regions of the ejector device. By means of the numerous possible combinations of the elements of the inclined ejector, a modular construction kit can thus be created by means of which inclined ejectors of different dimensions and embodiments can be provided for the production of manifold ejector devices.

### BRIEF DESCRIPTION OF THE FIGURES

Details of the invention will be explained in more detail with reference to an exemplary embodiment shown in the accompanying figures. Identical multiple references to a component in one and the same figure include both the singular and plural of the element shown. In the figures:

FIG. 1a shows a side view of a device for a casting process or an injection molding process with an illustration of several embodiments of the inclined ejector and a cast part having a plurality of undercuts still in engagement with the ejector device, representing the situation before the molding process (molding position);

FIG. 1b shows a side view of a device for a casting process or an injection molding process with an illustration of several embodiments of the inclined ejector and a cast part having several demolded sections, representing the situation immediately after ejection of the undercuts (demolding position);

FIGS. 2a, 2b show side views of a first embodiment of the inclined ejector with an ejector head fastened to the first end of the ejector element in the initial position (molding position);

FIGS. 3a, 3b show perspective views of a further embodiment of the inclined ejector in an intermediate position (during the ejection process);

FIGS. 4a, 4b show perspective views of a first embodiment of the inclined ejector in the final position (demolding position), without an ejector head fastened to the first end of the ejector element;

FIGS. 5a, 5b, 5c show side views of a further embodiment of the inclined ejector with a positive orientation of the coupling mechanism between the push element and the ejector element (gear-up/acceleration);

FIGS. 6a, 6b, 6c show side views of a first embodiment of the inclined ejector with a negative orientation of the coupling mechanism between the push element and the ejector element (gear-down/deceleration);

FIGS. 7a, 7b, 7c show a perspective view, a side view and a cross-section of the guide element;

FIGS. 8a, 8b, 8c show side views and a perspective view of an embodiment of the ejector element;

FIGS. 9a, 9b, 9c show side views and a perspective view of an embodiment of the push element;

FIGS. 10a, 10b, 10c, 10d, 10e show side views and a perspective view of different embodiments of the driver;

FIGS. 11a, 11b, 11c show side views of a further embodiment of the inclined ejector, a further embodiment of the ejector element, a further embodiment of the driver and a further embodiment of the recesses within the push element and the ejector element.

### DESCRIPTION OF EMBODIMENTS

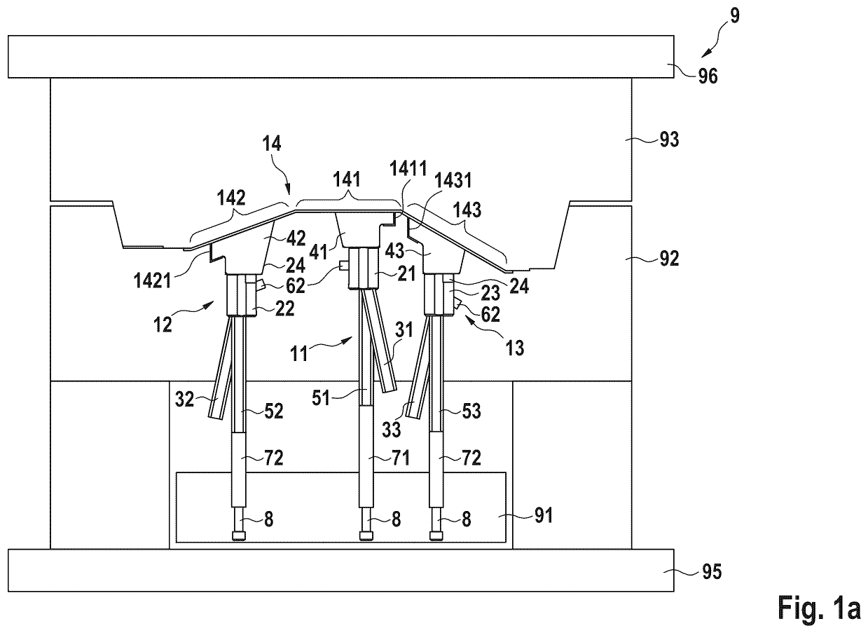

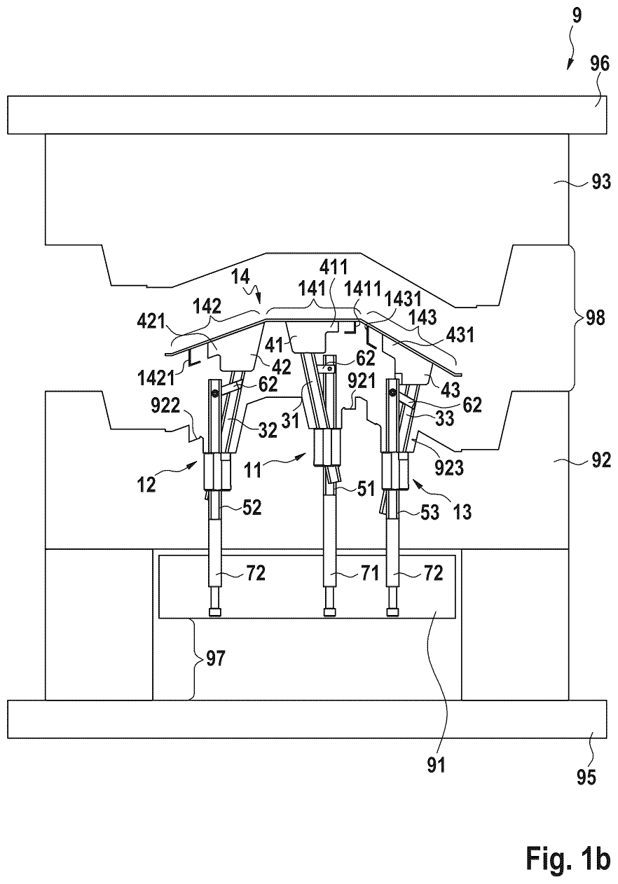

FIG. 1a shows different embodiments 11, 12, 13 of inclined ejectors located between two tool plates 95, 96 and between a core plate 92 and a cavity plate 93 of a device for a casting process or injection molding process 9 in a first position (molding position), the situation with the cavity plate 93 closed, immediately before the molding process of the cast part 14 with the demolding regions 141, 142, 143 and the undercuts 1411, 1421, 1431. The ejector elements 31, 32, 33 and the respective drivers 62 are in a first position (molding position). In this first position, the ejector heads 41, 42, 43 are still in positive engagement with the undercuts 1411, 1421, 1431 of the cast part 14.

The push elements 51, 52, 53 are each lengthened by a push-element extension 71, 72. The push-element extensions 71, 72 located within the ejector device and/or the push elements 51, 52, 53 are detachably fastened to the ejector plate 91 by a fastening means 8, the fastening means 8 in particular being a screw connection. The ejector plate 91 is in a first position (molding position). The guide elements 21, 22, 23 located within the ejector device are fastened to the core plate 92 by way of recesses 24 and fixing elements 27 (not shown). The ejector heads 41, 42, 43 of the inclined ejectors 11, 12, 13 lie, before the ejection process, in this first position within pockets 921, 922, 923 (not explicitly shown) which are arranged in the demolding region of the core plate 92.

FIG. 1b shows embodiments 11, 12, 13 of inclined ejectors located between two tool plates 95, 96 of a device for a casting process or injection molding process 9 in a second position (demolding position) within the free space 98 with the core plate 92 open, immediately after the ejection process and before demolding of the cast part 14 with the demolding regions 141, 142, 143 and the undercuts 1411, 1421, 1431. The ejector plate 91 has been moved into a second position (demolding position), the ejection cylinder (not shown) of the ejector device generating an ejection stroke 97 of the ejector plate 91.

The embodiment 11 of the inclined ejector has a driver 62 which assumes a neutral position characterized by an inclination angle β of in particular 90° between the longitudinal axis of the driver 62 and the longitudinal axis of the push element 51. The displacement of the push element 51 from a first into a second position causes a displacement of the ejector element 31 during which no velocity difference and thus no acceleration occurs between the push element 51 and the ejector element 31 during the ejection process. The push element 51 is lengthened by a push-element extension 71 in such a way that the demolding region 141 with the undercut 1411, raised relative to the demolding regions 142, 143, can be ejected.

The embodiment 12 of the inclined ejector has a driver 62 which assumes an acceleration position characterized by an inclination angle β greater than 90° between the longitudinal axis of the driver 62 and the longitudinal axis of the push element 51 or by an angle between +100° and +135° relative to the neutral position of 90° described above, such that the driver 62 points obliquely in the first direction toward the ejector head and forms an acute angle between the first end of the push element and the projecting end of the driver 62. The displacement of the push element 52 from a first into a second position causes an acceleration of the ejector element 32, so that a positive change in speed between the push element 52 and the ejector element 32 is generated during the ejection process. The push element 52 is lengthened by a push-element extension 72 in such a way that the demolding region 142 having the undercut 1421, which is angled/inclined relative to the demolding regions 141, 143, can be ejected.

The embodiment 13 of the inclined ejector 1 has a driver 62 which assumes a deceleration position characterized by a (negative) inclination angle β smaller than 90° between the longitudinal axis of the driver 62 and the longitudinal axis of the push element 51 or by an angle between 80° and 45° relative to the neutral position of 90° described above. The displacement of the push element 53 of embodiment 13 from a first into a second position causes a deceleration of the ejector element 33, so that a negative change in speed between the push element 53 and the ejector element 33 is generated during the ejection process. The push element 53 is lengthened by a push-element extension 72 in such a way that the demolding region 143 having the undercut 1431, which is angled/inclined relative to the demolding regions 141, 142, can be ejected.

The size of the free space 98 formed between the core plate 92 and the cavity plate 93 depends on the ejection stroke 97 of the ejector plate 91. The ejector plate 91 is shifted by a hydraulic ejection cylinder of the ejector device (not shown) by an ejection stroke 97 from a first into a second position (demolding position). In this step of the ejection process, the ejector heads 41, 42, 43 are no longer in positive engagement with the undercuts 1411, 1421, 1431 but are adhesively connected to the cast part 14. During the ejection process, the ejector heads 41, 42, 43 move into a second position (demolding position) in that they move out of the pockets 921, 922, 923 which are arranged in the core plate 92. The respective push elements 51, 52, 53 move from the first position (molding position) into a second position (demolding position) by means of the ejection stroke 97, the respective push elements 51, 52, 53 being mounted so as to slide within the guide elements 21, 22, 23 in respective passages (not shown). The ejection stroke 97 achievable by the inclined ejector 1 is determined essentially by the length of the push elements 51, 52, 53 and/or the push-element extensions 71, 72 and by the movement of the ejector plate 91. Owing to the bending-stiff design of the push elements 51, 52, 53 and of the ejector elements 31, 32, 33, these can be displaced unguided and without mechanical bearing outside the guide elements 21, 22, 23 within the free space 98 that forms, into a second position (demolding position). The ejector heads 41, 42, 43 arranged on the ejector elements 31, 32, 33 remain in the second position (demolding position) within the free space 98. The ejector heads 41, 42, 43 may be provided with notches 411, 421, 431 which are released from the undercuts 1411, 1421, 1431 of the cast part 14. The cast part 14 rests on the ejector heads 41, 42, 43. In a downstream process step, the cavity plate 93 can either take the cast part 14 along by adhesion (not shown) or the cast part 14 can be removed from the device for a casting or injection molding process 9 (not shown).

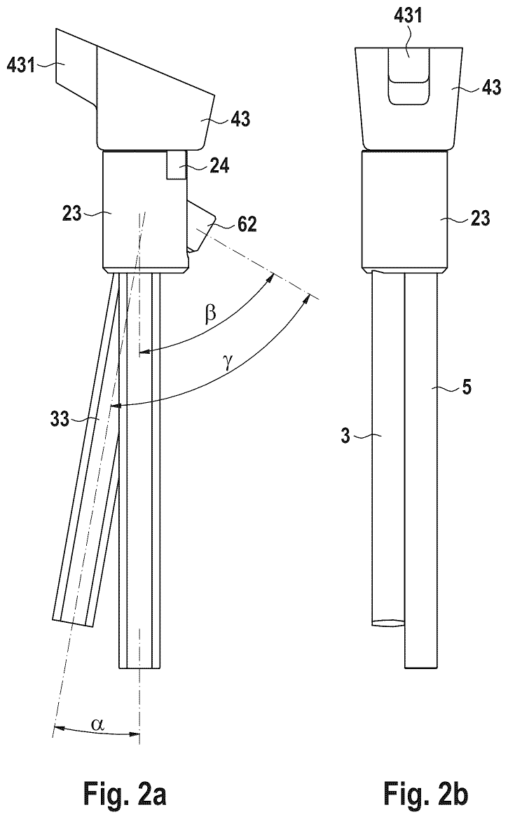

FIGS. 2a, 2b show embodiment 13 of an inclined ejector in a first position (molding position). The driver 62 is located, within the section of the guide element 23 facing away from the ejector head 43, at a mechanical stop of a guide slot 25 (not shown) facing away from the ejector head 43. In the section of the guide element 23 facing the ejector head 43 there is a recess 24 for accommodating a fixing element 27 (not shown). By means of the fixing element 27 (not shown), the guide element 23 can be detachably connected to a core plate 92 (not shown). A guide angle α is formed between the longitudinal axis of the push element 53 and the longitudinal axis of the ejector element 33. An inclination angle β is formed between the longitudinal axis of the push element 53 and the longitudinal axis of the driver 62; an inclination angle γ is formed between the longitudinal axis of the ejector element 33 and the longitudinal axis of the driver 62. The shape of the ejector head 43 as well as of the notch 431 is designed to slope, enabling a demolding region 143 (not shown) and an undercut 1431 (not shown) present therein to be received by embodiment 13 of the inclined ejector during the molding process (not shown) and to be ejected during the subsequent demolding process (not shown). In this context, sloping means that the demolding angle established during demolding corresponds to the angle of an undercut 1431 (not shown).

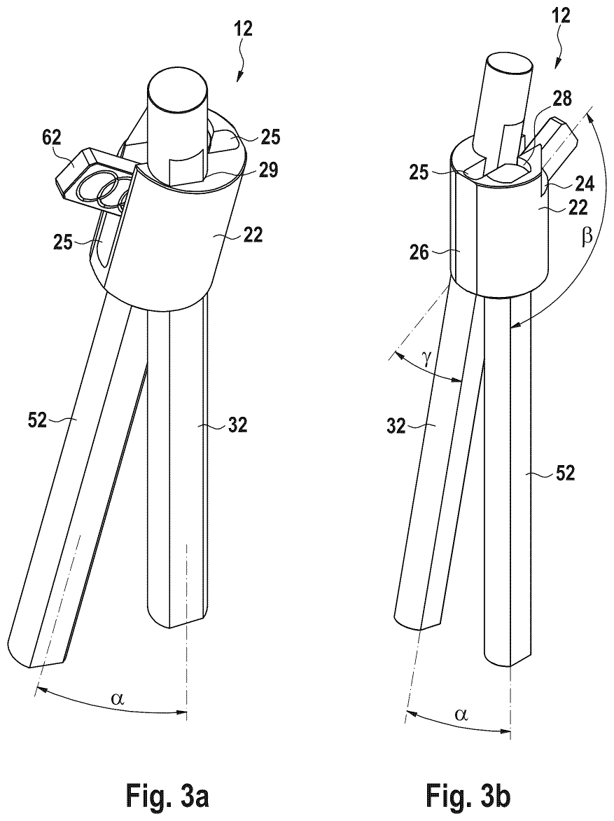

FIGS. 3a, 3b show embodiment 12 of an inclined ejector in a second position (after the molding process) at the beginning of the ejection process. The driver 62 is located within the section of the guide slot 25 of the guide element 22 facing the ejector head 42 (not shown). The longitudinal axis of the push element 52 forms a guide α with respect to the longitudinal axis of the ejector element 32. The guide angle α is determined by the angle of the longitudinal axes of the passages 28, 29 with respect to each other within the guide element 22. The longitudinal axis of the driver 62 forms, with respect to the longitudinal axis of the push element 52, a (positive) inclination angle β greater than 90°, and, with respect to the longitudinal axis of the ejector element 32, an inclination angle γ greater than 90°. The push element 52 and the ejector element 32 are preferably designed as flattened round bars and are guided in passages 28, 29 complementary thereto within the guide element 22. The guide element 22 may preferably have, on at least one side of its circular-cylindrical surface, a flat 261 which extends in the direction of the longitudinal axis of the guide element 22 and by means of which the guide element 22 can be received in a rotationally fixed manner in a recess formed complementary thereto within the core plate 92 (not shown) described above. As a result, torsions acting on the inclined ejector 12 during operation of a device for a casting or injection molding process 9 are absorbed by the core plate 92 (not shown), which is generally of solid design, which improves the stability and fatigue endurance of the ejector device and thus of the device for a casting or injection molding process 9. A recess 24 arranged in the first section of the guide element 22 accommodates a fixing element 27 (not shown), by means of which the guide element 22 can be detachably fastened to the core plate 92 (not shown).

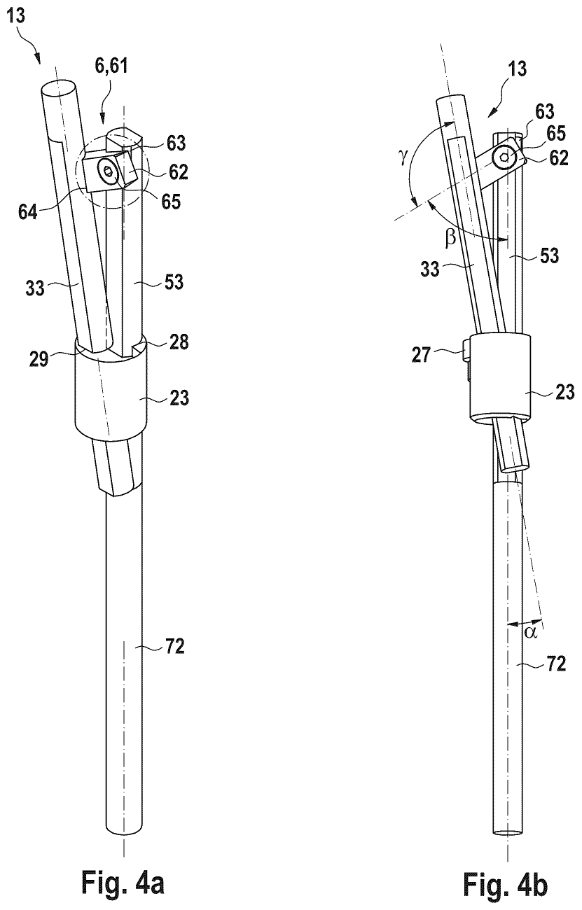

FIGS. 4a, 4b show embodiment 13 of an inclined ejector in a third position (demolding position) at the end of the ejection process, in which a negative gear action (deceleration) can be exerted from the push element 52 onto the ejector element 32 by means of the “negative” orientation of the driver 62. The ejection stroke 97 (not shown) of the ejection cylinder (not shown) and thus of the ejector plate 91 has reached a maximum value. By means of the driver 62 of the coupling mechanism 6 and the stabilization arrangement 61 contained therein (see indicated circle), the push element 53 and the ejector element 33 are operatively connected to each other. The driver 62 is partly accomodated and guided within a recess 63 in the push element 53 and partly within a recess 64 in the ejector element 33 and is in a third position (demolding position) which corresponds to an end position at the end of the ejection process. The longitudinal axis of the push element 53 forms a guide angle α with respect to the longitudinal axis of the ejector element 33. The longitudinal axis of the driver 62 forms, with respect to the longitudinal axis of the push element 53, a (negative) inclination angle β smaller than 90°, and, with respect to the longitudinal axis of the ejector element 33, an inclination γ smaller than 90°. A recess 24 (not shown) arranged in the section of the guide element 22 facing the ejector head 43 (not shown) accommodates a fixing element 27, by means of which the guide element 23 can be detachably fastened to the core plate 92 (not shown).

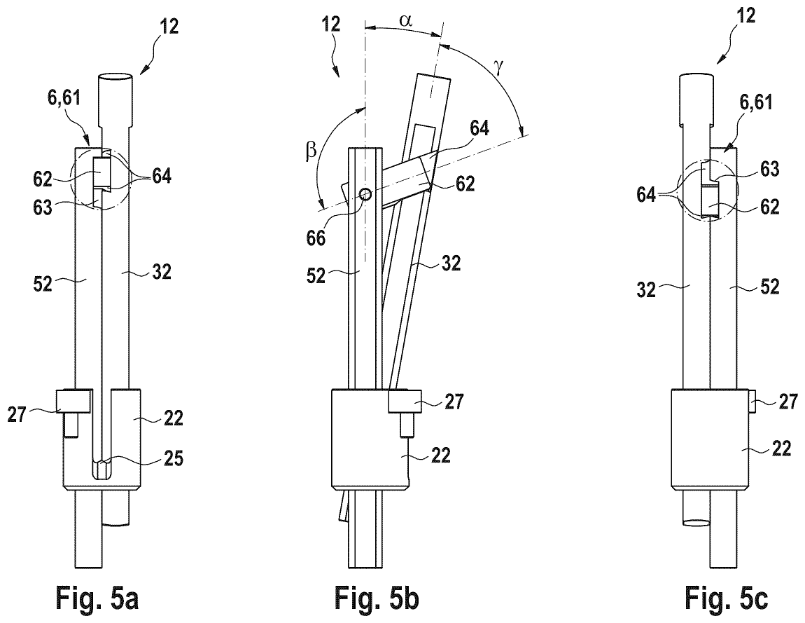

FIGS. 5a, 5b, 5c show embodiment 12 of an inclined ejector in a third position (demolding position), in which a positive gear action (acceleration) can be exerted from the push element 52 onto the ejector element 32 by means of the “positive” orientation of the driver 62. The longitudinal axis of the push element 52 forms a guide angle α with respect to the longitudinal axis of the ejector element 32. The longitudinal axis of the driver 62 forms an inclination angle β with respect to the longitudinal axis of the push element 52 and an inclination angle γ with respect to the longitudinal axis of the ejector element 33. By means of the driver 62 of the coupling mechanism 6 and the stabilization arrangement 61 contained therein (see indicated circle), the push element 52 and the ejector element 32 are operatively connected to each other. As described above, a “positive” position of the driver 62 at an inclination angle β greater than 90° with respect to the longitudinal axis of the push element 52 or at an inclination γ greater than 90° with respect to the longitudinal axis of the ejector element 32 produces, in the mechanical sense, a gear-up due to the mechanical coupling between the push element 52 and the ejector element 32, the driver 62 representing a cam in the mechanical sense. The gear-up produces an acceleration of the ejector element 32 during the displacement of the push element 52 into a second position (demolding position). Depending on the orientation of the driver 62, the ratio between the position of the driver 62 at the inclination angle β with respect to the push element 52 and the position of the driver 62 at the inclination angle γ with respect to the ejector element 32 and depending on the ejection stroke 97 of the ejection cylinder (not shown) and of the ejector plate 91, a greater or lesser “positive” gear action, i.e. a greater or lesser gear-up or a greater or lesser acceleration of the ejection process, can be produced by the embodiment 12 shown. In the third position (demolding position), the ejection stroke 97 can reach a maximum value. The driver 62 is partly accomodated and guided in a recess 63 in the push element 52 and partly in a recess 64 in the ejector element 32 and is in a third position (demolding position) which corresponds to an end position at the end of the ejection process. A recess 24 (not shown) arranged in the section of the guide element 22 facing the first end accommodates a fixing element 27, by means of which the guide element 22 can be detachably fastened to the core plate 92. A recess 66 for the fastening means 65 (not shown) of the driver 62 is arranged within the recess 63 of the push element 52.

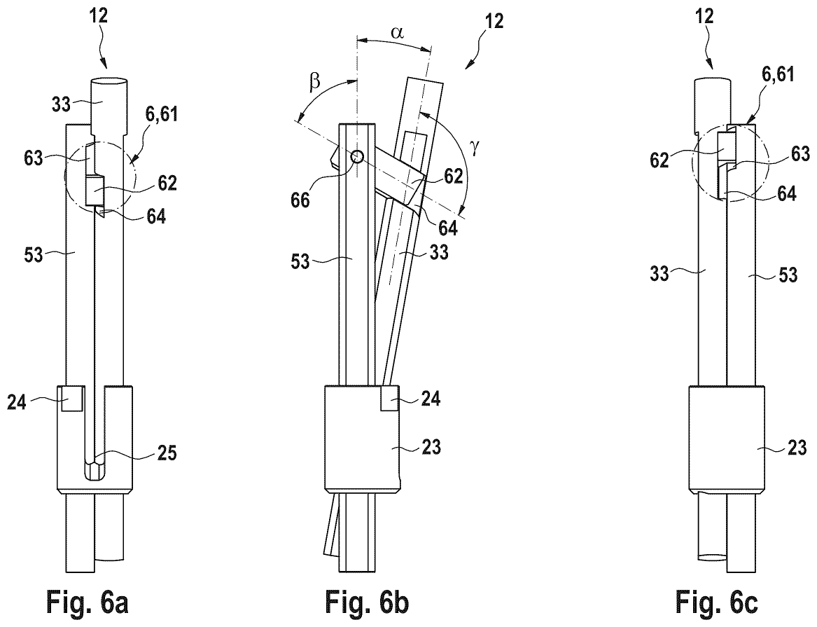

FIGS. 6a, 6b, 6c show embodiment 13 of an inclined ejector in a third position (demolding position) in which a “negative” gear action (deceleration) can be exerted from the push element 53 onto the ejector element 33 by means of the “negative” orientation of the driver 62. The longitudinal axis of the driver 62 forms an inclination angle β with respect to the longitudinal axis of the push element 53 and an inclination γ with respect to the longitudinal axis of the ejector element 33. By means of the driver 62 of the coupling mechanism 6 and the stabilization arrangement 61 contained therein (see indicated circle), the push element 53 and the ejector element 33 are operatively connected. As described above, a “negative” position of the driver 62 at an inclination angle β smaller than 90° with respect to the longitudinal axis of the push element 53 or at an inclination angle γ smaller than 90° with respect to the longitudinal axis of the ejector element 33 produces, in the mechanical sense, a gear-down due to the mechanical coupling between the push element 53 and the ejector element 33, the driver 62 representing a cam in the mechanical sense. The gear-down produces a deceleration of the ejector element 33 during the displacement of the push element 53 into a third position (demolding position). Depending on the orientation of the driver 62, the ratio between the position of the driver 62 at the inclination angle β with respect to the push element 53 and the position of the driver 62 at the inclination angle γ with respect to the ejector element 33 and depending on the ejection stroke 97 of the ejector plate 91, a greater or lesser negative gear action, i.e. a greater or lesser gear-down or a greater or lesser deceleration of the ejection process, can be produced by the embodiment 13 shown. The ejection stroke 97 has reached a maximum value which can be generated by the ejector device, namely the ejection cylinder (not shown), the ejector plate 91 (not shown), the push-element extension 72 (not shown) and the push element 53. The driver 62 is partly accomodated and guided in a recess 63 in the push element 53 and partly in a recess 64 in the ejector element 33 and is in a third position (demolding position) which corresponds to an end position at the end of the ejection process. The longitudinal axis of the push element 53 forms a guide α with respect to the longitudinal axis of the ejector element 33. A recess 24 arranged in the section of the guide element 22 facing the first end accommodates a fixing element 27 (not shown), by means of which the guide element 23 can be detachably fastened to the core plate 92. A recess 66 for a fastening means 65 (not shown) of the driver 62 is arranged within the recess 63 of the push element 53.

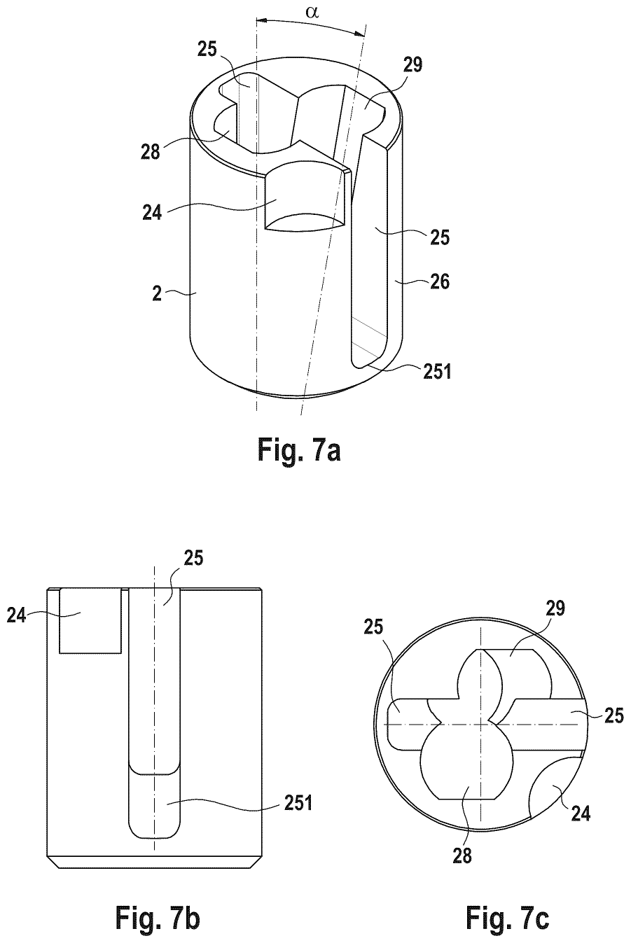

FIGS. 7a, 7b, 7c show the guide element 2 in the embodiment of a rotationally symmetrical, cylindrically designed body, in the manner of a bushing. The guide element 2 may preferably have, on its lateral surface 26, a flat 261 extending in the longitudinal direction. The guide element 2 may preferably be made of a metallic alloy, in particular of brass. Other materials conceivable for the production of the guide element 2 may be ceramics or metal sinter or 3-D laser sinter powders. Passages 28, 29 are provided in the guide element 2, which can preferably be produced by milling or EDM. The passages 28, 29 are arranged spaced apart from each other in their longitudinal direction at a guide angle α within the guide element 2. The passages 28, 29 are located eccentrically within the body of the guide element 2 and may constitute enlargements or flats of circular cross-sections which geometrically correspond to the cross-sections or the outer contours of the push element 5 or of the ejector element 3. As a result, both the push element 5 (not shown) and the ejector element 3 (not shown) can be displaced within the guide element 2 in the manner of a fit by means of the passages 28, 29, in particular without lubricant. The cross-sections of the passages 28, 29 partially overlap, these being arranged with respect to each other within the guide element 2 preferably in such a way that the push element 5 and the ejector element 3 are guided so as to be free of mutual contact. This ensures, on the one hand, that no positive or frictional engagement occurs between the push element 5 and the ejector element 3 within the guide element 2, which prevents the occurrence of friction and abrasion between the push element 5 and the ejector element 3. As a result, the guide element 2 and the passages 28, 29, the push element 5 and the ejector element 3 can be designed and operated to be wear-free and in particular free of lubricant, which contributes to the maintenance-free nature of the ejector device. A guide slot 25 is recessed in the guide element 2, which extends from the longitudinal middle of the body of the guide element 2 to the lateral surface 26 of the guide element 2 and can preferably be produced by milling or EDM. The guide slot 25 serves to accommodate the driver 62 of the coupling mechanism 6 (not shown), which can be displaced in the guide slot 25 free of friction and therefore free of wear, the driver 62 being able to plunge completely into the body of the guide element 2. The guide slot 25 has, in the section of the guide element 2 facing the second end, a mechanical stop 251 which constitutes a limit of the displacement of the driver 62. The guide slot 25 is open in the section of the guide element 2 facing the ejector head 4 (not shown) so that the driver 62 can be displaced during operation of the inclined ejector, in particular in the direction of the end of the guide element 2 facing the ejector head 4 (not shown). This makes it possible for the respective embodiment 11, 12, 13 of the inclined ejector to generate a maximum stroke between a first position (molding position), a second position (at the end of the molding process) and a third position (demolding position). A first position (molding position) of the driver 62 and of the coupling mechanism 61 is therefore not necessarily limited only to the space above the guide element 2. At the end of the guide element 2 facing the ejector head 4 (not shown), a recess 24 for accommodating a fixing element 27 (not shown) is recessed, by means of which the guide element 2 can be detachably fastened to the core plate 92 (not shown). Each guide element 2 can be received in a recess (not shown) in the core plate 92 (not shown) in such a way that the respective guide element 2 can be replaced easily. This enables a high degree of operational readiness of the ejector device.

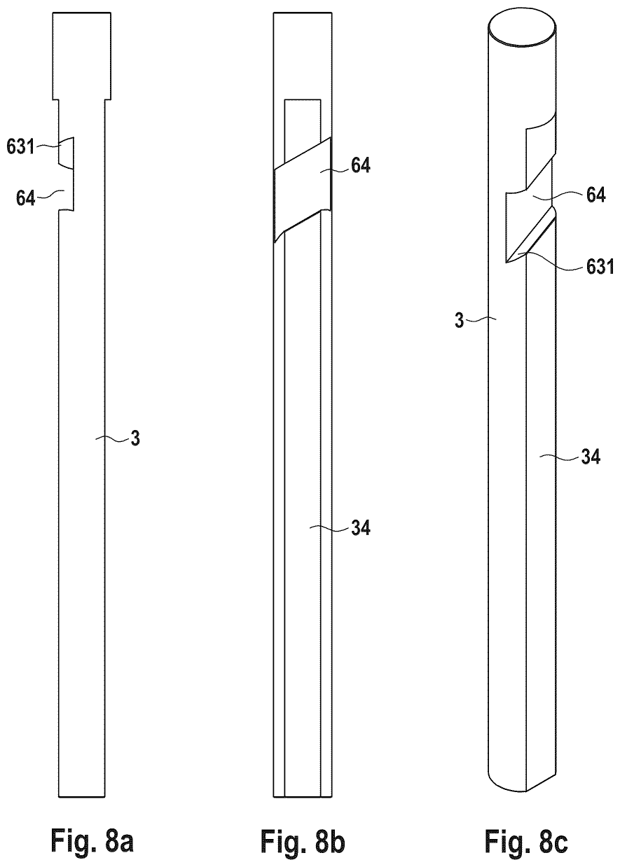

FIGS. 8a, 8b, 8c show a preferred embodiment of the ejector element 3. The ejector element 3 has the shape of a round bar which may have a flat 34 on one side. By means of the flat 34, the ejector element 3 can be mounted in a rotationally fixed manner within the passage 29 (not shown) of a guide element 2 (not shown), the passage 29 within the guide element 2 having, as described above, a cross-section complementary to the ejector element 3. The end of a recess 64 facing the ejector head 4 (not shown) and the end of the recess 64 facing away from the ejector head 4 (not shown) are, on the one hand, arranged parallel to each other and, on the other hand, arranged at an inclination γ with respect to the longitudinal axis of the ejector element 3. A recess 64 arranged in the ejector element 3 can accomodate a driver 62 (not shown). The end of the recess 64 facing the ejector head 4 (not shown) and the end of the recess 64 facing away from the ejector head 4 (not shown) constitute a first component of a stabilization arrangement 61 and may in a first embodiment of the ejector element 3 in particular be designed in the manner of, for example, a wedge-shaped undercut 631. The wedge-shaped undercut 631 present in the recess 64 serves to receive a second component of a stabilization arrangement 61 which may in particular be designed in the manner of a wedge-shaped guide strip 621 (not shown) of a driver 62 (not shown). The end of the recess 64 facing the ejector head 4 (not shown) and the end of the recess 64 facing away from the ejector head 4 (not shown) may, in a further embodiment of the ejector element 3, be designed as a rectangular undercut 632 (not shown). A rectangular undercut 632 (not shown) of the recess 64 serves to receive a rectangular guide strip 622 (not shown) of a driver 62 (not shown). By means of a first embodiment of the first and second components of the stabilization arrangement 61, namely by means of the wedge-shaped undercut 631 of the recess 64 and a wedge-shaped guide strip 621 of the driver 62 (not shown) designed complementary thereto, a deflection of the ejector element 3 in a second direction transverse to a different first direction of the translational movement of the ejector element 3 can be reduced, up to and including prevention of such a deflection, whereby stabilization of the inclined ejector can be effected by means of a stabilization arrangement 61 designed in this way during the ejection process, which contributes to the fatigue endurance of the ejector device. By means of a further embodiment of the stabilization arrangement 61, represented by a rectangular form of an undercut 632 (not shown) within the end of the recess 64 facing the ejector head 4 (not shown) and the end of the recess 64 facing away from the ejector head 4 (not shown) and a rectangular form of a guide strip 622 of the driver 62 (not shown) designed complementary thereto, stabilization of the inclined ejector can be produced by means of a stabilization arrangement 61 designed in this way during the ejection process.

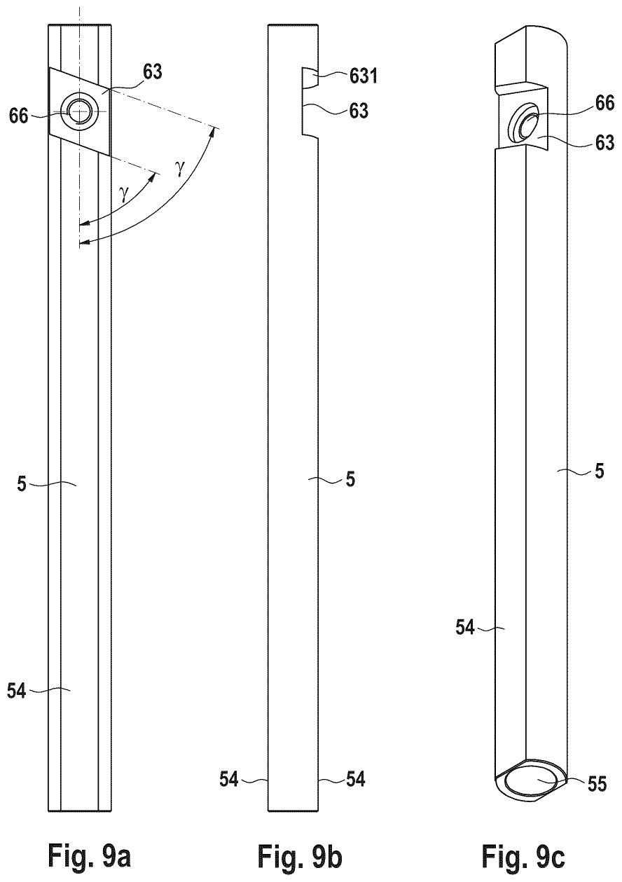

FIGS. 9a, 9b, 9c show a preferred embodiment of the push element 5. The push element 5 has the shape of a round bar which has a flat 54 on two of its sides. By means of the flats 54, the push element 5 can be mounted in a rotationally fixed manner within the passage 28 (not shown) of a guide element 3 (not shown), the passage 28 within the guide element 3 having a cross-section designed complementary thereto. A recess 63 arranged in the section of the push element 3 facing the ejector head 4 (not shown) can accomodate a driver 62 (not shown). The end of the recess 63 facing the ejector head 4 (not shown) or the end of the recess 63 facing away from the ejector head 4 (not shown) constitute a further component of the stabilization arrangement 61 described above and may, in a first embodiment, be designed in the manner of a wedge-shaped undercut 631. The end of the recess 63 facing the ejector head 4 (not shown) or the end of the recess 63 facing away from the ejector head 4 (not shown) may, in a further embodiment of the stabilization arrangement 61, be designed at right angles to the flat 54 and without the wedge-shaped undercut described above. By means of both embodiments of the stabilization arrangement 61, a deflection of the push element 5 in a second direction transverse to a first direction of the translational movement of the push element 5 can be reduced, up to and including prevention of such a deflection, whereby stabilization of the inclined ejector can be produced during the ejection process, which contributes to the fatigue endurance of the ejector device. The end of the recess 63 facing the ejector head 4 (not shown) and the end of the recess 63 facing away from the ejector head 4 (not shown) are, on the one hand, arranged parallel to each other and, on the other hand, arranged at an inclination angle β with respect to the longitudinal axis of the push element 5. A driver 62 can be arranged in the recess 63 in such a way that its orientation or its longitudinal axis assumes either an inclination angle β smaller than 90° or an inclination angle β greater than 90° with respect to the longitudinal axis of the push element 5. As a result, depending on the orientation of the coupling mechanism 6, the same push element 5 and the same driver 62 can produce either the gear-up (acceleration) described above or the gear-down (deceleration) described above on an ejector element 3 with a complementary design and orientation of the recess 64, which contributes to the modular variability of the inclined ejector concept. The push element 5 has, in the region of the recess 63, a recess 66 for a fastening means 65 (not shown), by means of which the driver 62 can be detachably fastened to the push element 5. The fastening means 65 may be designed as a screw or as a pin, for which purpose the recess 66 may be designed as a threaded bore or as a bore. At its end facing away from the ejector head 4 (not shown), the push element 5 has an insertion end 55 or a thread 55 for receiving a fastening means (not shown), by means of which a push-element extension 7 (not shown) can be placed on or screwed to the push element 5.

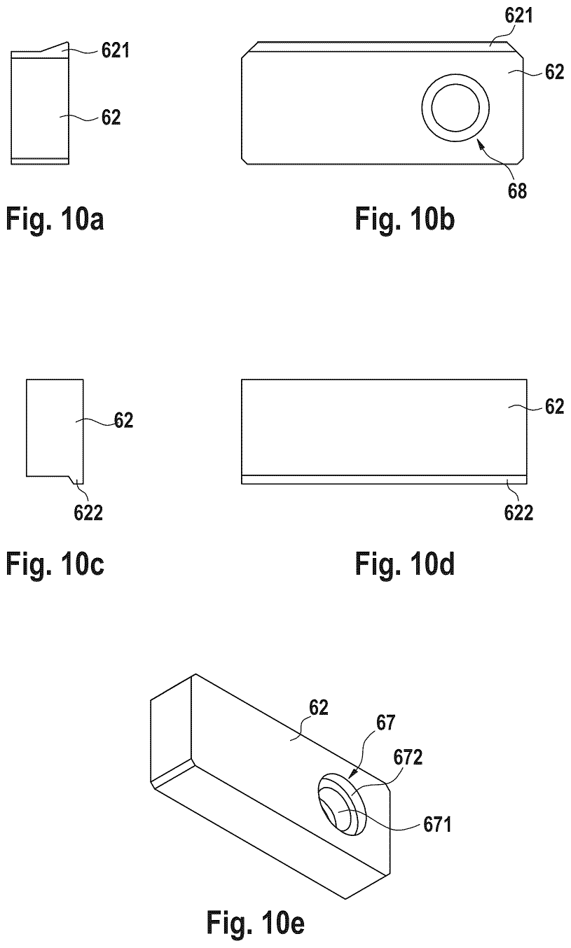

FIGS. 10a, 10b, 10c, 10d, 10e show different embodiments of the driver 62. In a preferred embodiment, a driver 62 according to FIGS. 10a, 10b can be used within a coupling mechanism 6 (not shown) of the inclined ejector according to the invention. The stabilization arrangement 61 (not shown) described above, as an integral component of the coupling mechanism 6 (not shown) described above, comprises, on the one hand, the driver 62, the first or second end of which may be designed as a wedge-shaped guide strip 621, and, on the other hand, a wedge-shaped undercut 631 (not shown) designed complementary thereto within a recess 63 or a recess 64 (not shown) for accommodating such a driver 62 within an ejector element 3 or a push element 5 (not shown). In a further embodiment, the embodiment of a driver 62 according to FIGS. 10c, 10d can be designed within a stabilization arrangement 61 of the inclined ejector according to the invention. In this further embodiment, the stabilization arrangement 61 described above may comprise, on the one hand, a driver 62 whose first or second end may be designed as a rectangular guide strip 622 and, on the other hand, a rectangular undercut 632 designed complementary thereto within a recess 63 or recess 64 of an ejector element 3 or of a push element 5 (not shown). In a further embodiment, an embodiment of a driver 62 according to FIG. 10e can be used within the coupling mechanism 6 of the inclined ejector according to the invention, the coupling mechanism 6 in such an embodiment of the inclined ejector being able to be designed without a stabilization arrangement 61. This further embodiment may be used in particular in inclined ejectors which are used in ejector devices within small-sized devices for a casting or injection molding process and in which small or no transverse forces occur between the ejector element 3 and the push element 5 during the ejection process. Such ejector devices do not require a stabilization arrangement 61 within the coupling mechanism 6. The first or the second end of a driver 62 designed in this way can be designed without a guide strip and accommodated within a recess 63 or a recess 64 in an ejector element 3 or in a push element 5. A recess 67 for accommodating the fastening element 65 (not shown) for fastening the driver 62 to the push element 5 (not shown) can be designed of a circular-cylindrical bore, wherein the circular-cylindrical bore can have a passage 671 and a bearing surface 672 for accommodating the aforementioned fastening means 65.

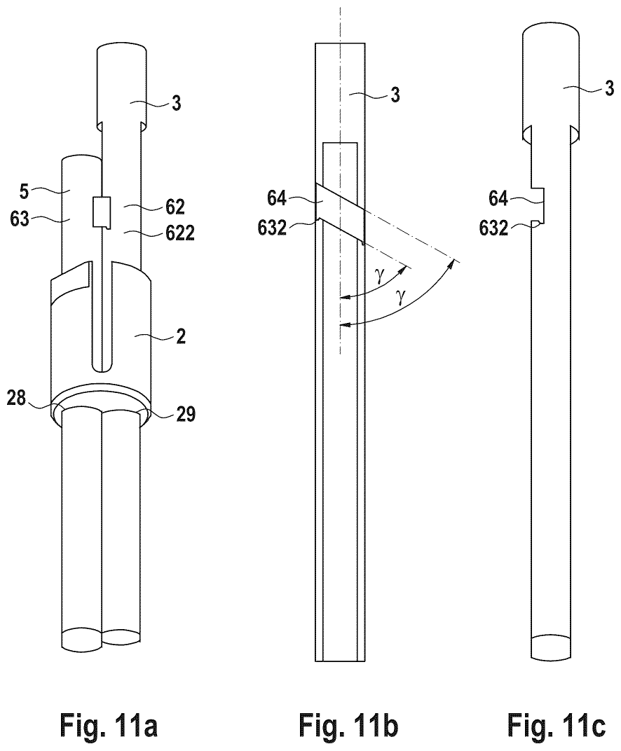

FIGS. 11 a, 11 b, 11 c show a further embodiment 13 of the inclined ejector. A push element 5 and an ejector element 3 are each guided in a guide element 2 by means of passages 28, 29 and are operatively connected to one another by means of a coupling mechanism 6 and a driver 62 as described above. The driver 62 is accommodated in a recess 63 within the push element 5 and in a recess 64 within the ejector element 3 as described above. The illustrated embodiment has, on the one hand, a driver 62, whose first end according to FIGS. 10c, 10d is designed without a guide rail and whose second end is designed as a rectangular guide rail 622, as well as a rectangular undercut 632 at the second end of the recess 64, for accommodating the driver 62. The first and second ends of the recess 64 can be, on the one hand, parallel to one another and, on the other hand, arranged at the angle of inclination γ with respect to the longitudinal axis of the ejector element 3. A driver 62 can be accommodated in the recess 64 of the ejector element 3 and the recess 63 of the push element 5 in such a way that its orientation and longitudinal axis describes either an angle of inclination γ of less than 90° with respect to the longitudinal axis of the ejector element 3 or an angle of inclination γ of greater than 90°. This enables, by means of a different orientation of the same driver 62, either the aforementioned step-up effect (acceleration) or the aforementioned step-down effect (deceleration) to be generated between the push element 5 and the ejector element 3, which contributes to the modular variability of the inclined ejector concept.

### REFERENCE LIST

1 Inclined ejector
11, 12, 13 Embodiments of the inclined ejector 1
14 Cast part
141, 142, 143 Demolding regions of the cast part 14
1411, 1421, 1431 Undercuts within the demolding regions 141, 142, 1 43 of the cast part 14
2 Guide element
21, 22, 23 Embodiments of the guide element 2
24 Receptacle for fixing element 27 on the guide element 2
25 Guide slot for accommodating the driver 62 in the guide element 2
251 Stop at the second end of the guide slot 25
26 Outer surface of the guide element 2
261 Flattening of the outer surface 26 of the guide element 2
27 Fixing element for fastening the guide element 2 to a cavity plate 92
28 Passage for accommodating a push element 5 in the guide element 2
29 Passage for accommodating an ejector element 3 in the guide element 2
3 Ejector element
31, 32, 33 Embodiments of the ejector element 3
34 Flattening on the ejector element 3
4 Ejector head
41, 42, 43 Embodiments of the ejector head 4
431 Notch of the ejector head 43
5 Push element
51, 52, 53 Embodiments of the push element 5
54 Flattening on the push element 5
55 Insertion end/screw thread for fastening means for fastening the push element extension 7
6 Coupling mechanism
61 Stabilization arrangement
Driver (cam)
621 Wedge-shaped guide rail as an embodiment of the section of the driver 62 facing the first end or facing the second end
622 Rectangular guide rail as an embodiment of the section of the driver 62 facing the first end or facing the second end
631 Undercut for accommodating the driver 62 with wedge-shaped guide rail (wedge shape)
632 Undercut for accommodating the driver 62 with rectangular guide rail (rectangular shape)
63 Recess for the driver 62 in the push element 5
64 Recess for the driver 62 in the ejector element 3
65 Fastening element for fastening the driver 62 to the push element 51, 52,53
66 Receptacle for the fastening means 65 within the push element 51, 52,53
67 Receptacle of the fastening element 65 for fastening the driver 62 to the push element 5
671 Passage within the receptacle 67
672 Bearing surface within the receptacle 67
7 Push element extension
71,72 Embodiments of the push element extension 7
8 Fastening means of the push element extension 7 to the ejector plate 91
9 Tool for a casting process or injection molding process
91 Ejector plate
92 Core plate (movable mold plate)
921, 922, 923 Recesses for accommodating the ejector heads 41, 42, 43 in the demolding region of the core plate 92
93 Cavity plate (fixed mold plate, injection molding plate or die-casting plate)
95,96 Tool plate (base plate or closing plate)
97 Ejection stroke of the ejector plate 91 (corresponds to the stroke of the ejection cylinder)
98 Free space between cavity plate 93 and the core plate 92
α Guide angle between the longitudinal axis of the push element 5 and the longitudinal axis of the ejector element 3
β Angle of inclination between the longitudinal axis of the push element 5 and the longitudinal axis of the driver 62
γ Angle of inclination between the longitudinal axis of the ejector element 3 and the longitudinal axis of the driver 62

1. Device, in particular inclined ejector, for demolding a cast part with an undercut from a cavity plate for a casting process or an injection molding process comprising:
a guide element;
an ejector element which is guided in the guide element in a translationally sliding manner in a first direction and has a first end which can be coupled to an ejector head;
a push element which is guided in the guide element in a translationally sliding manner in a second direction, wherein the first and second directions enclose a guide angle unequal to 0°.
a coupling mechanism which is designed to mechanically couple translational movements of the ejector element and the push element in their first and second directions respectively;
a stabilization arrangement which is arranged between the first end of the ejector element and the guide element in order to reduce a deflection of the ejector element transverse to the first direction of the translational movement of the ejector element or transverse to the second direction of the translational movement of the push element.

2. Device according to claim 1, wherein the stabilization arrangement and the coupling mechanism are formed together.

3. Device according to claim 1, wherein the stabilization arrangement has an elongated driver fixedly arranged on the push element as part of the coupling mechanism, which projects transversely from the push element with respect to its longitudinal extent in a first or second direction of extent, wherein a receptacle is provided on the ejector element in order to guide the driver on the ejector element along the longitudinal extent of the driver when the push element is moved translationally, and thereby to move the ejector element in the first direction.

4. Device according to claim 1, wherein the stabilization arrangement has a driver fixedly arranged on the ejector element as part of the coupling mechanism, which projects transversely from the ejector element with respect to its longitudinal extent in a first or second direction of extent, wherein a receptacle is provided on the push element in order to guide the driver on the push element along the longitudinal extent of the driver when the push element moves translationally, and thereby to move the ejector element in the first direction.

5. Device according to claim 3, wherein the mechanical coupling of the coupling mechanism is realized in that the driver carries the ejector element along in the first direction during a translational movement of the push element.

6. Device according to one of claim 3, wherein the longitudinal extent of the driver has an angle of inclination to the first direction of the ejector element or to the second direction of the push element which is less than 90° or greater than 90° with respect to the first or second direction of the ejector element and/or the push element, in order to realize a step-down or a step-up between the push element and the ejector element.

7. Device according to one of claim 3, wherein the guide element has a guide slot which is arranged so as to accommodate the driver depending on the translational position of the push element within the guide element.

8. Inclined ejector with a device according to claim 1, wherein the guide element is arranged in a core plate.

9. Inclined ejector with a device according to claim 1, wherein a particularly hydraulically driven ejection cylinder is provided which is designed to move the push element in the second direction.

10. Device according to claim 3, wherein the mechanical coupling of the coupling mechanism is realized in that the driver carries the ejector element along in the first direction during a translational movement of the push element.

11. Device according to claim 4, wherein the longitudinal extent of the driver has an angle of inclination to the first direction of the ejector element or to the second direction of the push element, which is less than 90° or greater than 90° with respect to the first or second direction of the ejector element and/or the push element, in order to realize a step-down or a step-up between the push element and the ejector element.

12. Device according to claim 5, wherein the guide element has a guide slot which is arranged so as to accommodate the driver depending on the translational position of the push element within the guide element.
